(19) United States
(12) Patent Application Publication
(10) Pub. No.: US 2022/0136964 A1
(43) Pub. Date: May 5, 2022

(54) ATOMIC ABSORPTION SPECTROMETER

(71) Applicant: Analytik Jena GmbH, Jena (DE)

(72) Inventors: Thomas Moore, Jena-Drackendorf (DE); Marco Braun, Jena (DE); Martin Hentschel, Jena (DE)

(21) Appl. No.: 17/427,123

(22) PCT Filed: Jan. 23, 2020
(86) PCT No.: PCT/EP2020/051629

§ 371 Date: Jul. 30, 2021

(30) Foreign Application Priority Data
Feb. 7, 2019 (DE) 10 2019 103 035.8

(51) Int. Cl. G01N 21/31; G01N 21/33; G01N 1/28

(52) U.S. Cl. CPC G01N 21/3103; G01N 21/33; G01N 2201/08; G01N 2201/062; G01N 2201/0636; G01N 1/28

(57) ABSTRACT

The present disclosure relates to an atomic absorption spectrometer for analyzing a sample, including a radiation source unit for generating a measuring beam, an atomization unit for atomizing the sample such that the atomized sample is located in a beam path of the measuring beam, and a detecting unit for detecting absorption of the measuring beam. The radiation source unit includes at least one light-emitting diode. According to the present disclosure, the detection unit includes a polychromator arrangement, in particular a high-resolution polychromator arrangement, as a spectrometric arrangement.

The present invention relates to an atomic absorption spectrometer for analyzing a sample.

Atomic absorption spectrometry relates to the quantitative and qualitative analysis of a particular element in a sample. The underlying measurement principles have become known from a multitude of publications and are described in, for example, “Atomabsorptionsspektrometrie [Atomic Absorption Spectrometry]” by Bernhard Welz and Michael Sperling (4th edition, WILEY VCH Verlag GmbH, Weinheim).

A measuring beam emanating from a radiation source is directed to a detection unit comprising a spectrometric arrangement and a photoelectric sensor. An atomization device is here arranged in the beam path of the measuring beam, in which atomization device the sample to be examined is atomized so that its components are present in the atomic state. Various methods are known for transitioning the sample into the gas phase. Atomization can, for example, be performed by means of a gas flame into which the sample to be analyzed is sprayed (flame atomic absorption spectrometry (F-AAS)); by electrothermal heating, usually in a graphite tube (AAS with electrothermal heating, or also graphite furnace technique (GF-AAS)); by chemical evaporation with subsequent heating (cold vapor technique (CV-AAS) or hydride technique (HS-AAS)), for example in a quartz glass tube.

The attenuation (absorption) of the measuring light beam due to interaction with the free atoms of the atomized sample is then, according to the Beer-Lambert law, a measure of the number or concentration of the sought element in the sample.

The required spectral measurement wavelengths A in atomic absorption spectroscopy lie between λ=193 nm for arsenic and λ=852 nm for cesium.

Ideally, the measuring beam is not influenced by the other elements contained in the sample to be analyzed. In many instances, however, in addition to the absorption caused by free atoms in the sample to be analyzed, what is known as background absorption also occurs, for example as a result of an absorption of the measuring beam by molecules. In order to compensate for this background absorption, it has become known, for example with regard to the graphite furnace technique, to utilize the Zeeman effect as described, for example, in documents DE 216510602, EP 0363457B1, or EP 0364539B1. Another possibility exists in the use of a broadband radiation source, such as a deuterium lamp, as a second radiation source.

The detection unit is thereby respectively adapted to the radiation source that is used and comprises both means for spectral separation of the radiation as well as means for the detection thereof by means of one or more photoelectric sensors. Monochromators or polychromators, for example, are used as a spectrometric arrangement. In turn, secondary electron multipliers, especially photomultipliers, or CCD sensors, CMOS sensors, CID sensors, or even photodiodes and photodiode arrays, are used as photoelectric sensors, for example.

The radiation source is in turn selected such that it contains the spectral lines of the respective element being sought. The spectral range that is used includes approximately the wavelength range from 190 nm to 850 nm. The ultraviolet (UV) region is hereby especially important because here most chemical elements have strong absorption lines.

A hollow-cathode lamp is frequently used in conjunction with an atomic absorption spectrometer, for example, as described in DE 1244956B. These radiation sources in which the cathode respectively consists of the chemical element to be determined are line emitters that emit the wavelength to be measured and have line widths in the pm range. The spectral resolution is thus defined by the radiation source itself.

When using hollow-cathode lamps, however, an element-specific radiation source is required for each element to be measured. Should the desired element change, the radiation source must be exchanged. An easy accessibility and replaceability, as well as a non-interchangeability of the individual lamps, must thereby be respectively ensured.

This entails several disadvantages: on the one hand, hollow-cathode lamps are comparatively expensive, fragile and large-volume special lamps with a limited service life. Further, due to unavoidable manufacturing tolerances, each lamp is usually realigned with each change. The changing devices required for this, by means of which the radiation source can be changed automatically or by the user, generally comprise numerous mechanical parts and possibly also servomotors and control electronics. This is accompanied by a large space requirement. In addition, the achievable measuring speed is limited by the respectively necessary mechanical movements.

The exchange of the radiation sources depending on the element to be examined moreover makes it necessary to respectively appropriately adjust the spectrometric arrangement, which is frequently a monochromator having a bandwidth in the nm range.

As an alternative to hollow-cathode lamps, the use of radiation sources which provide a continuous spectrum has also become known. Powerful UV radiation sources, such as the xenon short-arc lamps described for example in DE 112007000821T5, are especially to be mentioned here. In contrast to hollow-cathode lamps, such radiation sources are generally operated with spectrometric arrangements comprising a polychromator and with photoelectric sensors in the form of multiple photodiode arrangements, such as a photodiode array or a photodiode matrix, for example. The spectral resolution is thus achieved in this instance by the detection unit, for which correspondingly significantly higher requirements are to be set than in the instance of radiation sources in the form of hollow-cathode lamps. Given radiation sources with a continuous spectrum, on the other hand, there is advantageously no need for an additional radiation source for a compensation of background absorption. Background compensation thereby usually takes place simultaneously with measuring the element-specific absorption.

Given high-performance UV lamps whose principle of operation physically corresponds to that of what are known as “black body radiators”, it is problematic that, due to Wien's displacement law, they need to be operated at extremely high temperatures. Plasma temperatures of more than 10,000 K are necessary, for example, for the respective radiation power required in the UV range. However, these temperatures also provide extremely high light power levels in the visual range. In addition, high-performance UV lamps disadvantageously have a comparatively high power consumption. High-pressure lamps are also dangerous.

Deuterium lamps, for example, are available as an alternative to high-performance UV lamps. However, these in turn have considerable disadvantages with regard to the available radiation power. The radiation output of deuterium lamps decreases from the first hour of operation and, after approximately 12 weeks of continuous operation, will have reached approximately half the original radiation output, and they therefore will no longer be usable.

To be able to enable a plurality of elements without an exchange of the radiation source, even when hollow-cathode lamps are used, a simultaneously measuring multi-element atomic absorption spectrometer has become known from document DE4413096, for example. A plurality of hollow-cathode lamps are used as radiation source, while the detection unit comprises an echelle polychromator and a semiconductor surface receiver. The use of an echelle polychromator serves to prevent the overlapping of signals of the various hollow-cathode lamps. The analysis of a plurality of different elements is achieved via a mirror system by means of which the radiation of the individual hollow-cathode lamps is deflected in such a way that a limited solid angle range from each hollow-cathode lamp is combined into a measuring beam. It is thereby disadvantageous that the effective radiation power is reduced as the number of hollow-cathode lamps increases. In addition, the possible number of hollow-cathode lamps is clearly limited for design reasons.

One possibility for overcoming the design limitations is the use of optical waveguide bundles, as described in DE3924060, for example.

Another alternative to combining the various radiation sources into a single light bundle is to use a concave grating along what is known as a Rowland circle, as disclosed in document DE3608468. Via this measure, it is achieved that all of the hollow-cathode lamps that are used map their radiation power to a common slit.

Document DE102009003413A1 describes an echelle spectrometer with internal predispersion. Here, the radiation intensity can be appropriately adapted to the dynamic range of the respective detector by using what is known as a dispersive slit arrangement. Refer also in this context to “High-Resolution Continuum Source AAS: The Better Way to Do Atomic Absorption Spectrometry”, by Bernhard Welz, Helmut Becker-Roß, and Uwe Heitmann (2005, WILEY-VCH, ISBN 3-527-30736-2).

Among other things, atomic absorption lines of the various chemical elements and their bandwidths are given there. Moreover, it is shown both theoretically and experimentally which requirements a polychromatic spectrometer should satisfy for a radiation source that provides a continuous spectrum, thus for what is known as a continuum source (CS) atomic absorption spectrometer. Accordingly, the half-width values of the elements caused by Doppler and collision-spreading effects are, for example, 1.27 pM (selenium at 196.026 nm) or 2.54 pM (magnesium at 285.213 nm). Instrumental bandwidths AA of approximately twice the half-width of the elements are suitable for their detection. For a spectrometer which is just about able to separate the spectral lines of two wavelengths λ and λ+Δλ, the resolving power R is thereby usually defined as R=λ/Δλ.

Starting from the prior art, the present invention is based on the object of providing a radiation source for an atomic absorption spectrometer which is robust and simple to operate.

This object is achieved by an atomic absorption spectrometer for analyzing a sample, comprising a radiation source unit for generating a measuring beam, an atomization unit for atomizing the sample such that the atomized sample is located in a beam path of the measuring beam, and a detection unit for detecting an absorption of the measuring beam. The radiation source unit comprises at least one light-emitting diode. According to the invention, the detection unit furthermore comprises a polychromator arrangement, especially a high-resolution polychromator arrangement, as a spectrometric arrangement.

Light-emitting or luminescence diodes (LEDs) advantageously have high radiation outputs with well-defined half-widths which lie within a range of approximately 5-50 nm, depending on the centroid wavelength of the light-emitting diode. Accordingly, they provide a continuous spectrum that enables a multi-element analysis. The optical radiation power is thereby respectively available immediately, e.g., in contrast to other conventional radiation sources, there is no need to wait for burn-in or warm-up times. This opens up the possibility of switching on the radiation source respectively only as required, which in turn lengthens the service life.

The radiation power, which can be adjusted via the operating current, is thereby respectively limited to the spectral wavelength range of the light-emitting diode that is used. Accordingly, the respective detector is not charged by other, especially interfering, wavelengths. In addition, the occurrence of stray light is significantly reduced. The possibility of combining light-emitting diodes with lenses or fibers having focal intercepts in the sub-millimeter range also enables the transmission of comparatively large numerical apertures.

Furthermore, light-emitting diodes are characterized by their compactness—the required installation space is often within the range of a few cubic millimeters. In addition, light-emitting diodes are robust components which are comparatively insensitive to interfering mechanical influences, such as mechanical shocks or vibrations, and also to other environmental influences such as, for example, ambient temperature. Further advantages of using light-emitting diodes are that they are cost-effective, durable, and energy-efficient. As compared with thermal radiators, for example, little heat loss is transmitted into the respective optical system, so that lower requirements are to be set for the optical system with regard to compensating for and/or tolerating temperature drift. For example, individual light-emitting diodes make do with passive cooling or can be temperature-controlled with comparatively compact Peltier elements. Even the power supply to light-emitting diodes is significantly simpler than in the event of conventional radiation sources used in conjunction with atomic absorption spectrometers.

Overall, the use of one or more light-emitting diodes enables a substantially more robust and more compact design of the radiation source with lower manufacturing costs. Above all, it is possible to operate the spectrometer in a simple manner, especially with regard to the adjustment of the radiation source unit and the detection unit. This markedly extends the field of application to analyses in industrial processes, which often require continuous monitoring. One possible application example is monitoring the metal ion load in turbid wastewater, which needs to be monitored continuously and possibly clarified or reprocessed.

The respective wavelength range of the light-emitting diode being used can be selected for the specific application. Especially, numerous light-emitting diodes with wavelengths in the UV range are available.

A preferred embodiment of the present invention includes the geometry of the light-emitting diode being selected such that it is adapted to the geometric conditions of the detection unit, especially to an entrance aperture of the spectrometric arrangement. An adaptation of the geometry of a light-emitting diode can take place by means of a fiber cross-section converter, for example. A typical entrance aperture is a slit or a fiber-optic input, for example.

As already mentioned, the detection unit comprises a spectrometric arrangement and a photoelectric sensor. In the event that the spectrometric arrangement has an entrance slit, the geometry of the light-emitting diode can accordingly be adapted especially to the geometry of the entrance slit. For example, the light-emitting diode can be designed such that it has a geometry corresponding to the slit geometry.

Another preferred embodiment includes the radiation source unit comprising at least two light-emitting diodes. A first light-emitting diode especially generates light of at least one first wavelength, or of wavelengths within a first prespecifiable wavelength range, and the second light-emitting diode generates light of at least one second wavelength differing from the first wavelength, or of wavelengths within a second prespecifiable wavelength range differing at least partially from the first wavelength range.

In the event of a plurality of light-emitting diodes, the most diverse variants are conceivable with regard to the geometric embodiments. If an adaptation of the geometry of the radiation source to the geometry of the detection unit is provided, it is conceivable for the light-emitting diodes to be arranged and configured such that the totality of the light-emitting diodes is adapted to the geometry of the detection unit, for example to the geometry of an entrance slit of the spectrometric arrangement. In addition to the use of a plurality of light-emitting diodes with at least partially different wavelengths, it is self-evident that the respectively used light-emitting diodes can also generate light within the same wavelength range.

With regard to the use of at least two light-emitting diodes, it is advantageous if each of the at least two light-emitting diodes can be switched individually.

In this way, on the one hand a sequential analysis of different elements in the sample can be realized by operating the individual light-emitting diodes one after the other, as well as a simultaneous analysis of a plurality of elements in the sample by operating a plurality of light-emitting diodes simultaneously.

A preferred embodiment of the invention in conjunction with at least two light-emitting diodes provides that the radiation source unit is designed in such a way that the light of the first light-emitting diode is directed into a first sub-region of the detection unit, and the light of the second light-emitting diode is directed into a second sub-region of the detection unit. The light of the first and second light-emitting diodes is especially directed into a first and second sub-region of an entrance aperture, for example an entrance slit of the spectrometric arrangement. With this embodiment, both a sequential operation and a simultaneous operation of the individual light-emitting diodes is possible without any mechanical movement of the radiation source unit relative to the detection unit.

An alternative preferred embodiment includes that the radiation source unit is designed in such a way that the light of the first and second light-emitting diodes in the form of a total measuring beam is directed to the detection unit. The light from all light-emitting diodes is especially combined and then directed to the detection unit, especially to an entrance aperture of the spectral arrangement.

A further preferred embodiment with regard to a radiation source unit comprising at least two light-emitting diodes includes the at least two light-emitting diodes being arranged together on a carrier element. For example, a plurality of light-emitting diodes can be arranged laterally next to one another or along a circular path.

On the one hand, it is conceivable in this context for the carrier element to be fixedly arranged. On the other hand, a further preferred embodiment includes the carrier element being part of a positioning device by means of which the light-emitting diodes can be positioned relative to the detection unit. In this instance, the positioning device has the effect that a respective light-emitting diode is selected and appropriately positioned relative to the detection unit. This is especially advantageous for sequential operation of the individual light-emitting diodes. If the spectrometric arrangement has an entrance slit, the positioning device serves especially for positioning the individual light-emitting diodes relative to the entrance slit. In comparison with positioning devices known from the prior art, mechanical travel distances in the range of a few millimeters are sufficient for the present invention. This considerably simplifies the structures. In addition, considerably shorter adjustment times for alignment can be realized.

Another preferred embodiment in conjunction with a radiation source unit comprising at least two light-emitting diodes includes the presence of an optical system which is designed to direct to the detection unit the light generated by the first and/or second light-emitting diodes.

In this respect, it is advantageous if the optical system comprises at least one mirror, especially a movable mirror; an optical waveguide, especially an optical fiber, a light conductor rod, a light-mixing rod; a grating; or a planar waveguide structure, especially in the form of an integrated optics.

Furthermore, it is advantageous if the optical system comprises at least one interference filter or a dichroic mirror.

Finally, it is also advantageous if the optical system comprises at least one Y-coupler; at least two fibers fused together; or a planar structure, especially in the form of an integrated optics.

In yet another preferred embodiment, the polychromator arrangement is a spectrometric arrangement with a resolution capability in the picometer range or less; it is especially a spectrometric arrangement with a resolution capability from R=50,000 to R=150,000.

In this respect, it is again advantageous if the polychromator arrangement comprises an echelle spectrometer, a Rowland circle spectrometer, or a virtually imaged phased-array spectrometer. Such polychromator arrangements can possess an entrance aperture, especially an entrance slit, or a plurality of, preferably mutually offset, entrance apertures, especially entrance slits.

For a spectrometric arrangement with a polychromator, a multiple photodiode arrangement, such as a photodiode array or a photodiode matrix, is suitable as the detector.

Another preferred embodiment includes the radiation source unit comprising the at least one light-emitting diode and at least one hollow-cathode lamp or UV radiation source. In this instance, the light-emitting diode can be used for compensating the background radiation, for example, while the actual measuring beam is provided by the hollow-cathode lamp or UV radiation source. In comparison with the prior art, this permits a simpler design than in the instance of a deuterium lamp for background compensation.

In summary, the present invention allows the spectral ranges necessary for the respective intended applications to be suitably assembled. The most diverse variants are conceivable here. For example, a powerful light-emitting diode operating in the visual spectrum can be combined with one or more specific light-emitting diodes in the UV range. For example, it can thus be achieved that the light of the UV light-emitting diodes, which are generally less powerful, can be directed to the detection unit as losslessly as possible. For example, the spectral range from approx. 210 nm into the NIR region can be successively assembled at prespecifiable wavelength intervals via various AlGaN, InAlGaN, InGaN light-emitting diodes. It is also possible to use frequency-doubled laser diodes for special spectral ranges. In order to take into account different intensities of different light-emitting diodes, luminophores can also be used. Both sequential and simultaneous analyses can thereby be achieved in a wide variety of ways.

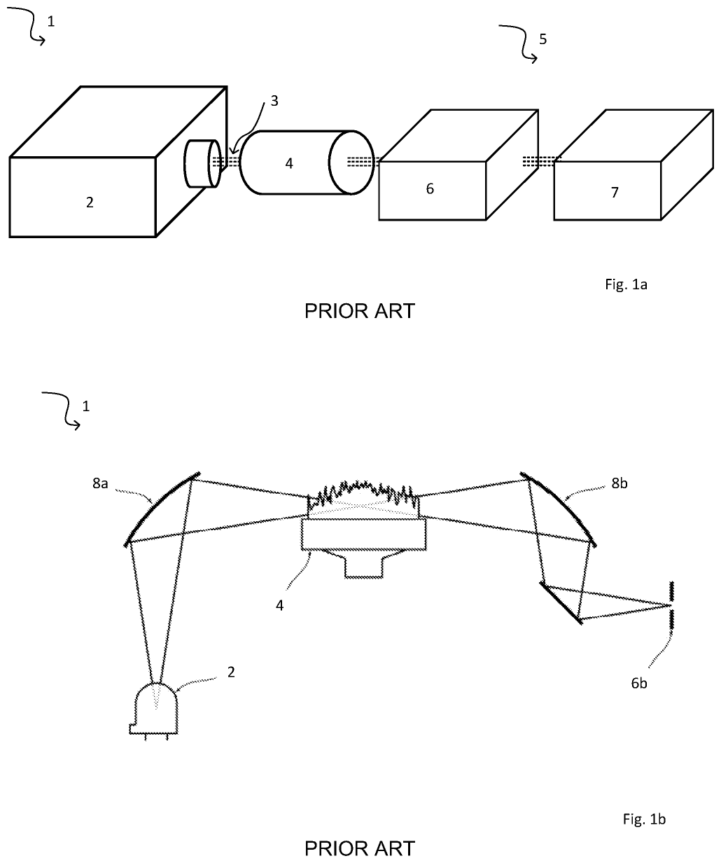

The invention is explained in greater detail below based on figures FIG. 1-FIG. 5. Illustrated are:

FIG. 1: a schematic representation of an atomic absorption spectrometer according to the prior art, in the form of (a) an atomic absorption spectrometer based on graphite furnace technology, and (b) a flame atomic absorption spectrometer;

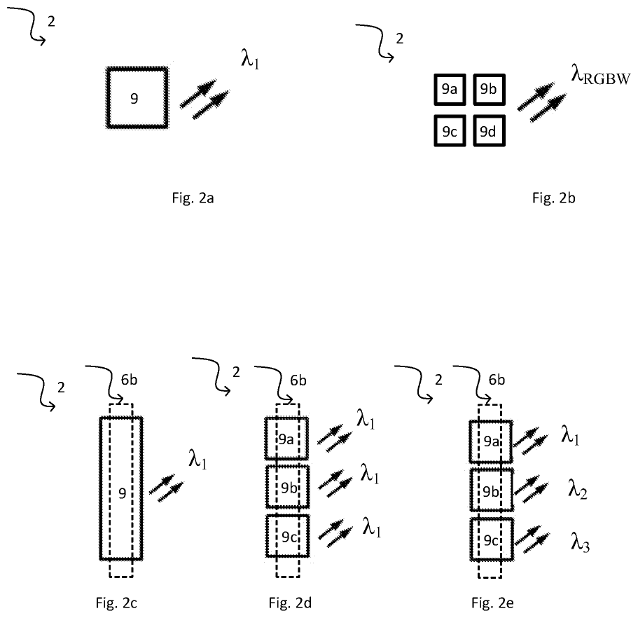

FIG. 2: possible embodiments of a radiation source unit, with (a) a light-emitting diode, (b) a plurality of light-emitting diodes, and (c-e) adaptation of the geometry to the geometry of the detection unit;

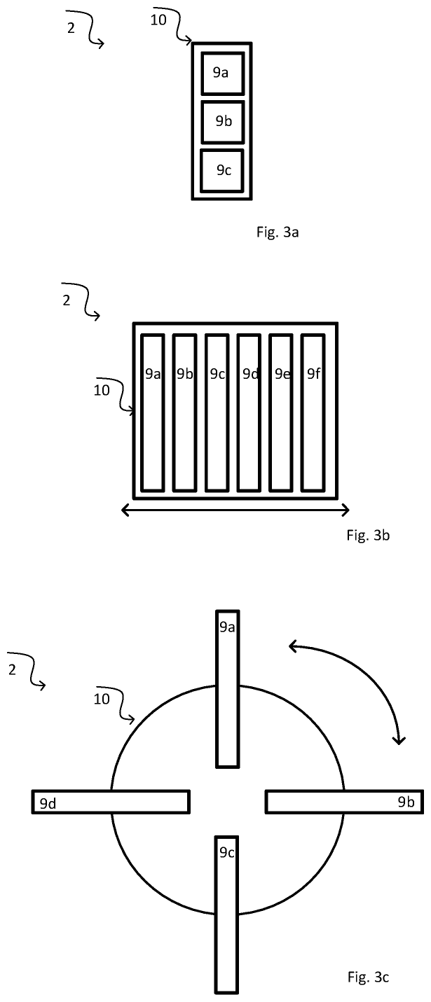

FIG. 3 possible embodiments of a radiation source unit using a carrier element (a) without and (b, c) with geometric adaptation to the detection unit, as well as various options for positioning individual light-emitting diodes relative to the detection unit;

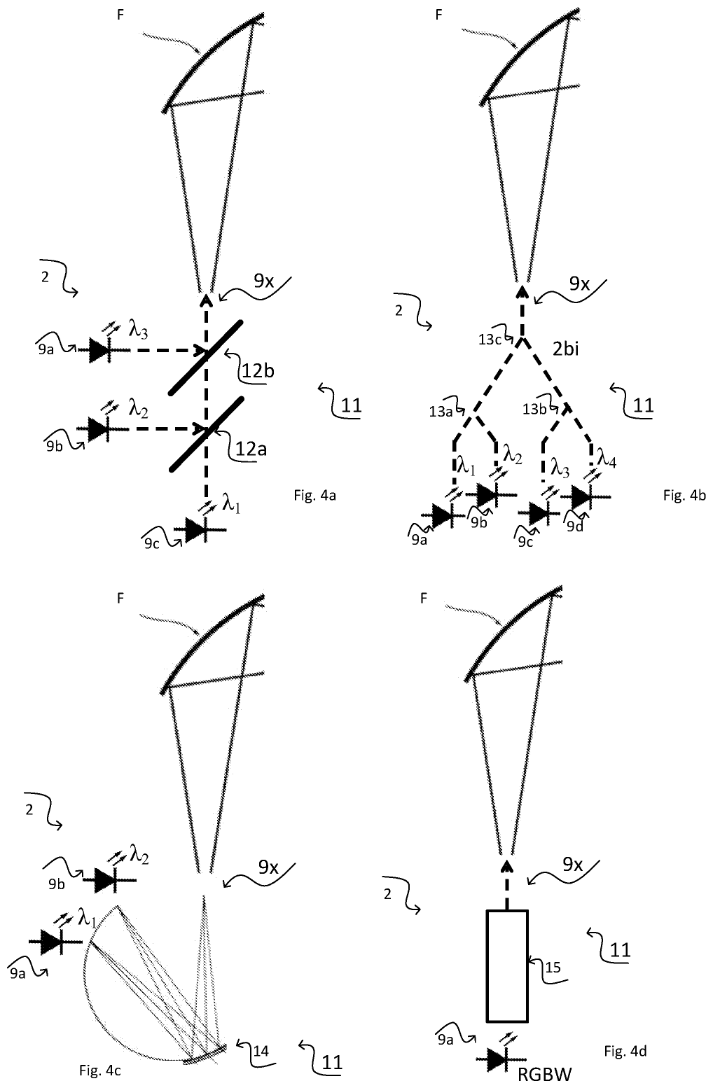

FIG. 4 possible embodiments of a radiation source unit with a plurality of light-emitting diodes whose light is directed jointly to the detection unit; and

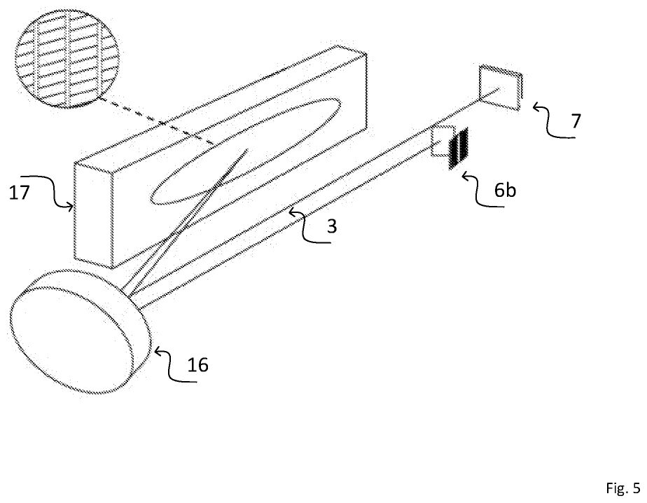

FIG. 5 a preferred embodiment of a detection unit in the form of a Littrow arrangement with crossed echelle grating structure.

In figures, identical elements are respectively provided with the same reference symbols.

Shown in FIG. 1a is a schematic representation of an atomic absorption spectrometer 1 that uses graphite furnace technology. Starting from the radiation source unit 2, a measuring beam 3 is emitted which passes through the atomizing device 4 in the form of a graphite tube. An atomized sample to be examined is located in the atomizing device 4. The radiation source unit 2 has at least one lamp which is selected such that the measuring beam 3 contains the spectral lines of the element being sought in the sample. Absorption of the measuring beam 3 results in an attenuation, which can be detected in a detection unit 5 that follows the atomization device 4. The detection unit 5 comprises a spectrometric arrangement 6 and an optoelectronic sensor 7, which optionally possesses integrated or connected evaluation electronics.

In contrast to the atomic absorption spectrometer 1 in FIG. 1a, the spectrometer 1 shown in FIG. 1b is a flame atomic absorption spectrometer 1. In addition to components already described in reference to FIG. 1a, the shown spectrometer 1 has a mirror system 8 with two mirrors 8a, 8b for guiding the measuring beam 3. Further, in FIG. 1b the spectrometric arrangement 6, which may be a monochromator or polychromator, for example, is by way of example represented by an entrance slit 6b through which the measuring beam 3 passes into the detection unit 5.

The following description relates to possible embodiments for the radiation source unit 2. According to the invention, the radiation source unit 2 comprises at least one light-emitting diode (LED) 9 as shown by way of example in FIG. 2a.

The most diverse embodiments known from the prior art can be used as light-emitting diodes in conjunction with the present invention. Planar light-emitting diodes, edge-emitting or side-emitting light-emitting diodes, or even dome-type light-emitting diodes are preferably used.

In FIG. 2a is a planar light-emitting diode 9 which generates light of wavelength λ₁. The respective spectral range of the light-emitting diode 9 can thereby be selected specific to the application. The UV range is especially of interest since many elements which are of interest for an analysis have their spectral lines within this range.

In the context of the present invention, a plurality of light-emitting diodes 9a-9d can also be used, as depicted in FIG. 2b. These can in turn respectively generate light of different wavelengths λ₁-λ₄. In the instance of the embodiment according to FIG. 2b, the individual light-emitting diodes 9a-9d are selected, for example, in such a way that together they generate light in a broad wavelength range λ_{RGBW}.

It is advantageous if the geometry of the light-emitting diode 9 is selected such that it is adapted to the geometric conditions of the detection unit 5. In the event that the spectrometric arrangement 6 has an entrance slit 6b, and/or in the event of a stigmatically imaging optical arrangement, it is accordingly advantageous if the light-emitting diode 9 has a geometry corresponding to the geometry of the entrance slit 6b, as depicted in FIG. 2c. This permits an optimum illumination of the sensor 7. However, an anamorphic arrangement can also be resorted to in order to be able to achieve optimum illumination of the sensor.

In the event that a plurality of light-emitting diodes 9a, 9b, . . . are used, it is conceivable on the one hand that each light-emitting diode 9 is adapted with regard to its geometry to the geometry of the detection unit. That is to say that each light-emitting diode 9a, 9b, . . . is designed corresponding to the variant illustrated in FIG. 2c. In this context, however, it is likewise conceivable to design the radiation source unit 2 such that the plurality of light-emitting diodes 9a-9c that are used are adapted in their entirety to the geometry of the detection unit 5, especially to the geometry of the entrance slit 6b of the spectrometric arrangement 6, as illustrated in FIGS. 2d and 2e for the instance of using three light-emitting diodes 9a-9c. Here, it is again conceivable on the one hand that all light-emitting diodes 9a-9c generate light of the same wavelength λ₁ as in the instance of FIG. 2d. On the other hand, the light-emitting diodes 9a-9c may in part or all generate light of different wavelengths λ₁-λ₃, as in the instance of FIG. 2e.

Via the arrangement of a plurality of light-emitting diodes 9a, 9b, 9c next to one another, as in the instance of FIG. 2e, different partial regions T1, T2 of the sensor 7 can respectively be illuminated with the light of different wavelengths λ₁-λ₃. This allows a simultaneous multi-element analysis of the correspondingly designed atomic absorption spectrometer 1.

A further embodiment of the present invention includes the different light-emitting diodes 9a, 9b, being arranged together on a carrier element 10, as shown by way of example in FIG. 3 for the instance of an embodiment according to FIG. 2e. The embodiment in FIG. 3a is a carrier element 10 which can be fixedly positioned relative to the detection unit 5 since, with one position of the carrier element 10, all light-emitting diodes 9a-9c can be used for analyzing the respective sample.

However, it is also conceivable to configure the radiation source unit 2 in such a way that a sequential operation of the individual light-emitting diodes 9a, 9b, . . . is achieved, as shown in FIGS. 3b and 3c. For the embodiment from FIG. 3b, for example, six light-emitting diodes 9a-9f are arranged next to one another on the carrier element 10. The carrier element 10 here is part of a positioning unit (not shown) by means of which a lateral movement of the carrier element 10 relative to the detection unit 5 can be realized for the embodiment shown here, as indicated by the arrow. The different light-emitting diodes 9a-9f can thus be positioned one after the other in such a way that they respectively illuminate the sensor 7 to analyze different elements in the sample. In addition to a lateral movement, other possibilities for accomplishing a sequential positioning of the individual light-emitting diodes 9a-9f are also conceivable. By way of example, FIG. 3c shows an arrangement of four light-emitting diodes 9a-9d arranged on a round carrier element 10 which can respectively be positioned relative to the detection unit via a circular movement of the carrier element 10.

FIG. 4 shows four further possible embodiments for a radiation source unit 2 according to the invention, for which a respective optical system 11 which is designed to guide the light generated by the light-emitting diodes 9a, 9b to the detection unit 5. The light of the individual light-emitting diodes 9a, 9b, . . . is thereby respectively combined in such a way that all light-emitting diodes 9a, 9b illuminate the same surface of the sensor 7. The light of the individual light-emitting diodes 9a, 9b, . . . is especially combined to form a total measuring beam 9x.

According to FIG. 4a, the optical system 11 comprises two interference filters 12a, 12b; for FIG. 4b, the light of the individual light-emitting diodes is combined by means of three Y-couplers 13a-13c. By contrast, for FIG. 4c the optical system comprises a grating 14, and for FIG. 4d a light-mixing rod 15. The light-mixing rod 15 shown in FIG. 4d is of cylindrical form. It is to be noted that, in other embodiments, the light-mixing rod 15 can also be conical, for example, that is to say in the form of a taper.

Within the scope of the present invention, it is preferably that the spectrometric arrangement 6 have high spectral resolution; the resolution is preferably a few picometers. Various spectrometric arrangements which are fundamentally suitable in the context of the present invention are known to the person skilled in the art, for example from Wilfried Neumann, “Fundamentals of dispersive optical spectroscopy systems” (SPIE Monograph, ISBN: 9780819498243).

In the instance of a radiation source unit 2 having at least one light-emitting diode 9, conventional monochromatic spectral arrangements are generally rather unsuitable since they must be tuned sequentially according to the bandwidth of the light-emitting diode 9. Transient absorption events, as can be measured by the graphite furnace technique, especially require the use of spectral arrangements 6 in the form of polychromators, which are preferably used in combination with fast-readable optoelectronic multipixel sensors 7. Examples of such spectrometric arrangements 6 are, for example, the Rowland circle spectrometer, the virtually imaged phased-array spectrometer, or also the echelle spectrometer.

Echelle spectrometers with echelle gratings have a high spectral resolution, which is based on the use of high atomic numbers. However, due to the spectral overlap associated therewith, additional measures for order separation are respectively necessary. For this reason, echelle gratings are often combined in combination with prisms, gratings or grisms.

FIG. 5 shows a preferred embodiment for a detection unit 5 in the form of a Littrow arrangement with a crossed echelle structure, into which is integrated a transversely dispersive element for order separation. A measuring beam 3 travels through an entrance slit 6b of the spectrometric arrangement, is collimated at a concave mirror 16, passes the crossed echelle grating 17, and is then refocused via the concave mirror 16 to the sensor 7.

### REFERENCE SIGNS

1 Atomic absorption spectrometer
2 Radiation source unit
3 Measuring beam
4 Atomizing device
5 Detection unit
6 Spectrometric arrangement
6b Entrance aperture, entrance slit
7 Sensor
8 Mirror system
8a, 8b Mirror
9, 9a, 9b Light-emitting diode
9x Total measurement beam
10 Carrier element
11 Optical system
12a, 12b Interference filter
13a-13c Y-coupler
14 Grating
15 Light-mixing rod
16 Concave mirror
17 Echelle grating
λ, λ₁, λ₂, . . . Wavelengths
T1, T2 Partial regions
F Surface

1-15. (canceled)

16. An atomic absorption spectrometer for analyzing a sample, the atomic absorption spectrometer comprising:
a radiation source unit configured to generate a measuring beam, wherein the radiation source unit comprises at least one light-emitting diode;
an atomization unit configured to atomize the sample such that the atomized sample is disposed in a beam path of the measuring beam; and
a detection unit configured to detect an absorption of the measuring beam, wherein the detection unit comprises a polychromator arrangement as a spectrometric arrangement.

17. The atomic absorption spectrometer of claim 16, wherein a geometry of the radiation source unit is configured such that the radiation source unit is adapted to geometrical conditions of the detection unit.

18. The atomic absorption spectrometer of claim 17, wherein the geometrical conditions of the detection unit include an entrance aperture of the spectrometric arrangement.

19. The atomic absorption spectrometer of claim 16, wherein the at least one light-emitting diode of the radiation source unit comprises at least two light-emitting diodes, wherein a first light-emitting diode generates light of at least a first wavelength or with wavelengths within a predefined first wavelength range, and wherein a second light-emitting diode generates light of at least a second wavelength different from the first wavelength, or with wavelengths within a predefined second wavelength range differing at least partially from the first wavelength range.

20. The atomic absorption spectrometer of claim 19, wherein each of the at least two light-emitting diodes is individually switchable.

21. The atomic absorption spectrometer of claim 19, wherein the radiation source unit is configured such that the light of the first light-emitting diode is directed into a first partial region of the detection unit and such that the light of the second light-emitting diode is directed into a second partial region of the detection unit.

22. The atomic absorption spectrometer of claim 19, wherein the radiation source unit is configured such that the light of the first light-emitting diode and the light of the second light-emitting diode is directed to the detection unit as a combined measuring beam.

23. The atomic absorption spectrometer of claim 19, wherein the at least two light-emitting diodes are arranged together on a carrier element.

24. The atomic absorption spectrometer of claim 23, wherein the carrier element is part of a positioning device configured to enable the at least two light-emitting diodes to be positioned relative to the detection unit.

25. The atomic absorption spectrometer of claim 19, further comprising an optical system configured to direct the light generated by the first light-emitting diode and/or the second light-emitting diode to the detection unit.

26. The atomic absorption spectrometer of claim 25, wherein the optical system comprises at least one mirror, an optical waveguide, a light guide rod, a light mixing rod, a grating and/or a planar waveguide structure.

27. The atomic absorption spectrometer of claim 26, wherein the at least one mirror is configured as a mirror, and/or the optical waveguide is an optical fiber.

28. The atomic absorption spectrometer of claim 25, wherein the optical system comprises at least one interference filter.

29. The atomic absorption spectrometer of claim 25, wherein the optical system comprises at least one Y-coupler, at least two fibers fused together and/or a planar structure.

30. The atomic absorption spectrometer of claim 16, wherein the polychromator arrangement has a resolution capability in the picometer range or less.

31. The atomic absorption spectrometer of claim 30, wherein the polychromator arrangement has a resolution capability of R=50,000 to 150,000.

32. The atomic absorption spectrometer of claim 31, wherein the polychromator arrangement comprises an echelle spectrometer, a Rowland circle spectrometer, or a virtually imaged phased-array spectrometer.

33. The atomic absorption spectrometer of claim 16, wherein the radiation source unit comprises the at least one light-emitting diode and at least one hollow-cathode lamp or UV radiation source.
